(19) United States
(12) Patent Application Publication
(10) Pub. No.: US 2024/0170718 A1
(43) Pub. Date: May 23, 2024

(54) SOLID ELECTROLYTE MATERIAL AND BATTERY INCLUDING THE SAME

(71) Applicant: Panasonic Intellectual Property Management Co., Ltd., Osaka (JP)

(72) Inventor: MASASHI SAKAIDA, Hyogo (JP)

(21) Appl. No.: 18/418,296

(22) Filed: Jan. 21, 2024

Related U.S. Application Data
(63) Continuation of application No. PCT/JP2022/027920, filed on Jul. 15, 2022.

(30) Foreign Application Priority Data
Aug. 6, 2021 (JP) 2021-130375

(51) Int. Cl. H01M 10/0562; H01M 10/052

(52) U.S. Cl. CPC H01M 10/0562; H01M 10/052; H01M 2300/008

(57) ABSTRACT

A solid electrolyte material according to the present disclosure includes a crystal phase containing Li, Zr, Al, and F. The X-ray diffraction pattern of the solid electrolyte material obtained by X-ray structure analysis using Cu-Kα radiation has at least two peaks in a first range of diffraction angle 2θ from 21.2° to 23.5°, at least two peaks in a second range of diffraction angle 2θ from 29.3° to 31.8°, and at least two peaks in a third range of diffraction angle 2θ from 37° to 40.3°.

### BACKGROUND

### 1. Technical Field

The present disclosure relates to a solid electrolyte material and a battery including the solid electrolyte material.

### 2. Description of the Related Art

Japanese Unexamined Patent Application Publication No. 2011-129312 discloses an all-solid-state battery including a sulfide solid electrolyte.

Japanese Unexamined Patent Application Publication No. 2008-277170 discloses LiBF₄ as a fluoride solid electrolyte material.

### SUMMARY

One non-limiting and exemplary embodiment provides a solid electrolyte material having improved heat resistance.

In one general aspect, the techniques disclosed here feature a solid electrolyte material containing a crystal phase containing Li, Zr, Al, and F, wherein an X-ray diffraction pattern of the solid electrolyte material obtained by X-ray structure analysis using Cu-Kα radiation has at least two peaks in a first range of diffraction angle 2θ from 21.2° to 23.5°, at least two peaks in a second range of diffraction angle 2θ from 29.3° to 31.8°, and at least two peaks in a third range of diffraction angle 2θ from 370 to 40.3°.

The present disclosure provides a solid electrolyte material having improved heat resistance.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a battery 1000 according to a second embodiment;

FIG. 2 is a graph showing the X-ray diffraction patterns of solid electrolyte materials according to Examples 1 to 3 and Reference Example 1;

FIG. 3 is a schematic view of a compression molding die 300 used to evaluate the ion conductivity of a solid electrolyte material;

FIG. 4 is a graph showing the Cole-Cole plot obtained by impedance measurement of the solid electrolyte material according to Example 1;

FIG. 5 is a graph showing the conductivity retention rate of solid electrolyte materials according to Examples 1 to 3 and Reference Example 1 after a heat treatment; and

FIG. 6 is a graph showing the initial discharge characteristics of batteries according to Example 1 and Comparative Example 1.

### DETAILED DESCRIPTIONS

Embodiments of the present disclosure will be described below with reference to the drawings.

### First Embodiment

A solid electrolyte material according to a first embodiment contains a crystal phase containing Li, Zr, Al, and F. The X-ray diffraction pattern of the solid electrolyte material according to the first embodiment obtained by X-ray structure analysis using Cu-Kα radiation has at least two peaks in a first range of diffraction angle 2θ from 21.2° to 23.5°, at least two peaks in a second range of diffraction angle 2θ from 29.3° to 31.8°, and at least two peaks in a third range of diffraction angle 2θ from 370 to 40.3°.

According to the above configuration, the solid electrolyte material according to the first embodiment has high heat resistance.

Containing the crystal phase described above, the solid electrolyte material according to the first embodiment has high heat resistance.

In the present disclosure, the phrase “has at least two peaks in a predetermined range (e.g., the first range)” includes the meaning of “has two peaks that can be clearly separated from each other in a predetermined range.” The phrase “can be clearly separated from each other” means that the peak positions 2θ₁ and 2θ₂ of two peaks and the full widths 2Δθ₁ and 2Δ6₂ at half maximum of the respective peaks satisfy at least |2θ₂-2θ₁|≥(2Δθ₁+2Δθ₂).

The peak angle refers to an angle at which the intensity of a projecting part that has a SN ratio greater than or equal to 1.5 and a full width at half maximum less than or equal to 3° shows the maximum. The full width at half maximum refers to the width represented by a difference between two diffraction angles at which the intensity is a half of the maximum intensity I_{MAX} of the peak. The SN ratio is the ratio of signal S to background noise N.

The crystal phase is not limited to a particular crystal structure and may have, for example, a crystal structure described below.

A half or more of cations other than Li constituting the solid electrolyte material according to the first embodiment may have an anion coordination number of 6 in the crystal structure. In other words, a half or more of cations other than Li constituting the solid electrolyte material according to the first embodiment may be six-coordinated. The coordination of six anions around each of a half or more of cations other than Li in the crystal structure can be determined by, for example, Rietveld analysis based on X-ray diffraction profiles.

All of cations other than Li constituting the solid electrolyte material according to the first embodiment may have an anion coordination number of 6 in the crystal structure.

Examples of such a crystal structure include a material having a composition represented by Li₃AlF₆. Hereinafter, the crystal structure of Li₃AlF₆ is referred to as a “LAF structure” or “Li₃AlF₆ structure.” The LAF structure can be classified into the Zn₄Ta₂O₉ structure of space group C2/c. A detailed atomic arrangement of the structure is described in Inorganic Crystal Structure Database (ICSD) (ICSD No. 25226).

The solid electrolyte material according to the first embodiment may contain a different crystal phase having a crystal structure different from that of the crystal phase described above.

In the solid electrolyte material according to the first embodiment, the presence of two or more ions having different ion radii, such as Zr and Al, in the crystal structure may introduce distortion in the structure. As a result, regions with unstable Li potential may be generated. This form pathways for diffusion of lithium ions. In addition, the presence of Zr having a high valence provides a Li-deficient composition to form unoccupied sites and thus facilitates conduction of lithium ions. This may further improve the lithium-ion conductivity.

The process for producing an all-solid-state battery using a solid electrolyte material includes a heating step in many cases. Specific examples of the heating step include a step of drying the applied slurry, and a heating and pressing step for improving contact between particles. Therefore, the solid electrolyte material according to the first embodiment is preferably stable up to about 250° C. The formation of the crystal structure like the crystal phase described above can make the structure stronger and improve heat stability.

The solid electrolyte material according to the first embodiment may be used for providing a battery having good charge/discharge characteristics. Examples of the battery include all-solid-state batteries. All-solid-state batteries may be primary batteries or secondary batteries.

The solid electrolyte material according to the first embodiment is preferably free of sulfur. The solid electrolyte material free of sulfur has high safety because the solid electrolyte material does not produce hydrogen sulfide even if exposed to the atmosphere. The sulfide solid electrolyte disclosed in Japanese Unexamined Patent Application Publication No. 2011-129312 may produce hydrogen sulfide if exposed to the atmosphere.

Since the solid electrolyte material according to the first embodiment contains F, the solid electrolyte material may thus have high oxidation resistance. This is because F has a high redox potential. Since F has high electronegativity, F forms a relatively strong bond with Li. As a result, the solid electrolyte material containing Li and F normally has low lithium-ion conductivity. For example, LiBF₄ disclosed in Japanese Unexamined Patent Application Publication No. 2008-277170 has an ion conductivity as low as 6.67× 10⁻⁹ S/cm. The solid electrolyte material according to the first embodiment further containing Zr and Al in addition to Li and F may have an ion conductivity, for example, greater than or equal to 7×10⁻⁹ S/cm.

The X-ray diffraction pattern of the solid electrolyte material according to the first embodiment may be obtained by X-ray diffraction analysis based on the θ-2θ method using Cu-Kα radiation (wavelength 1.5405 Δ and 1.5444 Δ, i.e., wavelength 0.15405 nm and 0.15444 nm).

The X-ray diffraction pattern of the solid electrolyte material according to the first embodiment may have at least two peaks in a fourth range of diffraction angle 2θ from 150 to 20°. The solid electrolyte material containing such a crystal phase has higher heat resistance.

The crystal phase contained in the solid electrolyte material according to the first embodiment may have a Li₃AlF₆ structure or a distorted Li₃AlF₆ structure. The distorted Li₃AlF₆ structure refers to, for example, a structure having anion arrangement distorted by mixing of cations having different ion radii.

To improve the ion conductivity of the solid electrolyte material, the solid electrolyte material according to the first embodiment may contain an anion other than F. Examples of the anion include Cl, Br, I, O, and Se.

To improve the oxidation resistance of the solid electrolyte material, the ratio of the amount of substance of F to the total amount of substance of anions constituting the solid electrolyte material according to the first embodiment may be greater than or equal to 0.50 and less than or equal to 1.0.

The solid electrolyte material according to the first embodiment may consist essentially of Li, Zr, Al, and F. The phrase “solid electrolyte material according to the first embodiment consists essentially of Li, Zr, Al, and F” means that the ratio (i.e., molar fraction) of the total amount of substance of Li, Zr, Al, and F to the total amount of substance of all elements constituting the solid electrolyte material according to the first embodiment is greater than or equal to 90%. For example, the ratio (i.e., molar fraction) may be greater than or equal to 95%. The solid electrolyte material according to the first embodiment may consist of Li, Zr, Al, and F.

The solid electrolyte material according to the first embodiment may contain unavoidable elements. Examples of the elements include hydrogen, oxygen, and nitrogen. These elements may be present in raw material powders of the solid electrolyte material or in an atmosphere where the solid electrolyte material is manufactured or stored.

To further improve the ion conductivity of the solid electrolyte material, the ratio of the amount of substance of Li to the total amount of substance of Zr and Al in the solid electrolyte material according to the first embodiment may be greater than or equal to 1.12 and less than or equal to 5.07.

The solid electrolyte material according to the first embodiment may contain a crystal phase represented by the following formula (1).

Li_{6-(4-x)b}(Zr₁₋ₓAlₓ)_{b}F₆ (1)

In the formula (1), 0<x<1 and 0<b≤1.5 are satisfied. The solid electrolyte material having such a crystal phase has high ion conductivity.

To improve the ion conductivity of the solid electrolyte material, 0.01≤x≤0.99 may be satisfied, 0.2≤x≤0.95 may be satisfied, 0.4≤x≤0.95 may be satisfied, or 0.5≤x≤0.9 may be satisfied in the formula (1).

The upper limit and the lower limit in the range of x in the formula (1) may be defined by any combination of values selected from 0.01, 0.2, 0.4, 0.5, 0.5, 0.7, 0.8, 0.95, and 0.99.

To improve the ion conductivity of the solid electrolyte material, 0.7≤b≤1.3 may be satisfied, or 0.9≤b≤1.04 may be satisfied in the formula (1).

The upper limit and the lower limit in the range of b in the formula (1) may be defined by any combination of values selected from 0.7, 0.8, 0.9, 0.96, 1, 1.04, 1.1, 1.2, and 1.3.

The solid electrolyte material according to the first embodiment may be Li_{2.5}Zr_{0.5}Al_{0.5}F₆, Li_{2.8}Zr_{0.2}Al_{0.8}F₆, or Li_{2.9}Zr_{0.1}Al_{0.9}F₆.

The solid electrolyte material according to the first embodiment may have any shape. Examples of the shape include needle shape, spherical shape, and ellipsoid shape. The solid electrolyte material according to the first embodiment may be in the form of particles. The solid electrolyte material according to the first embodiment may have a pellet or plate shape.

When the solid electrolyte material according to the first embodiment has, for example, a particle shape (e.g., spherical shape), the solid electrolyte material may have a median diameter greater than or equal to 0.1 μm and less than or equal to 100 μm, or may have a median diameter greater than or equal to 0.5 μm and less than or equal to 10 μm. With this configuration, the solid electrolyte material according to the first embodiment and other materials (e.g., active material) may be dispersed well. The median diameter means a particle size at a cumulative volume of 50% in the volume-based particle size distribution. The volume-based particle size distribution is measured by, for example, a laser diffraction analyzer or an image analyzer.

### Method for Manufacturing Solid Electrolyte Material

The solid electrolyte material according to the first embodiment is manufactured by, for example, the following method.

Two or more halide raw material powders weighed so as to obtain an intended composition are mixed with an organic solvent in a mixer.

When the intended composition is, for example, Li_{2.8}Zr_{0.2}Al_{0.8}F₆, LiF, ZrF₄, and AlF₃ are prepared at a molar ratio of about 2.8:0.2:0.8. The raw material powders may be prepared at a molar ratio previously adjusted so as to compensate for compositional changes that may occur during the synthesis process. The raw material powders and the organic solvent are placed in a mixer, such as a planetary ball mill, and mixed while being pulverized. In other words, processing is performed by wet ball milling. The raw material powders may be mixed before being placed in the mixer.

A slurry in which the particles obtained by separating balls after mixing are dispersed is dried at a temperature according to the boiling point of the organic solvent used, and the obtained solid material is ground in a mortar to produce a reaction product.

The reaction product may be heat-treated in vacuum or in an inert gas atmosphere. The heat treatment is performed at, for example, a temperature higher than or equal to 100° C. and lower than or equal to 300° C. for 1 hour or longer. To prevent or reduce compositional changes during the heat treatment, the heat treatment may be performed in a closed container, such as a quartz tube.

As described above, a mixture containing a solvent and a raw material composition including the components of the solid electrolyte material is processed by wet ball milling to produce the solid electrolyte material according to the first embodiment.

The solvent used in wet ball milling may be at least one selected from the group consisting of γ-butyrolactone, propylene carbonate, butyl acetate, ethanol, dimethyl sulfoxide, and tetralin. In view of the dielectric constant of the solvent, the solvent may be N-methyl-2-pyrrolidone (NMP).

### Second Embodiment

A second embodiment will be described below. The same matters as described in the first embodiment are appropriately omitted.

A battery according to a second embodiment includes a positive electrode, an electrolyte layer, and a negative electrode. The electrolyte layer is disposed between the positive electrode and the negative electrode.

At least one selected from the group consisting of the positive electrode, the electrolyte layer, and the negative electrode contains the solid electrolyte material according to the first embodiment.

Containing the solid electrolyte material according to the first embodiment, the battery according to the second embodiment has good charge/discharge characteristics.

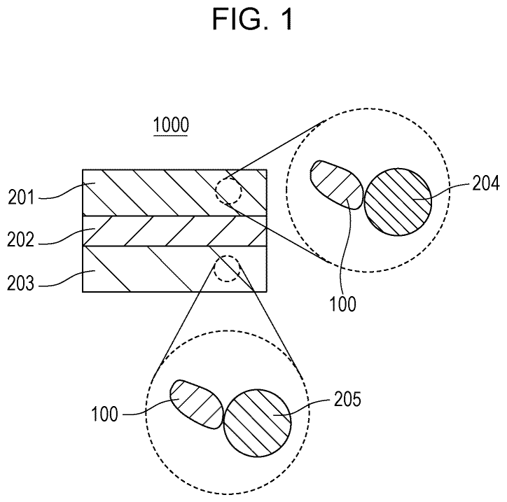

FIG. 1 is a cross-sectional view of a battery 1000 according to the second embodiment.

The battery 1000 according to the second embodiment includes a positive electrode 201, an electrolyte layer 202, and a negative electrode 203. The electrolyte layer 202 is disposed between the positive electrode 201 and the negative electrode 203.

The positive electrode 201 contains a positive electrode active material 204 and a solid electrolyte 100.

The electrolyte layer 202 contains an electrolyte material.

The negative electrode 203 contains a negative electrode active material 205 and the solid electrolyte 100.

The solid electrolyte 100 contains, for example, the solid electrolyte material according to the first embodiment. The solid electrolyte 100 may be particles containing the solid electrolyte material according to the first embodiment as a main component. The particles containing the solid electrolyte material according to the first embodiment as a main component mean particles containing the solid electrolyte material according to the first embodiment as a component having the highest molar ratio. The solid electrolyte 100 may be particles composed of the solid electrolyte material according to the first embodiment.

The positive electrode 201 contains a material capable of intercalating and deintercalating metal ions (e.g., lithium ions). The material is, for example, the positive electrode active material 204.

Examples of the positive electrode active material 204 include lithium-containing transition metal oxides, transition metal fluorides, polyanion, fluorinated polyanion materials, transition metal sulfides, transition metal oxyfluorides, transition metal oxysulfides, and transition metal oxynitrides. Examples of lithium-containing transition metal oxides include Li(Ni,Co,Mn)O₂, Li(Ni,Co,Al)O₂, and LiCoO₂.

In the present disclosure, “(A,B,C)” means “at least one selected from the group consisting of A, B, and C.”

The shape of the positive electrode active material 204 is not limited to a particular shape. The positive electrode active material 204 may be in the form of particles. The positive electrode active material 204 may have a median diameter greater than or equal to 0.1 μm and less than or equal to 100 μm. When the positive electrode active material 204 has a median diameter greater than or equal to 0.1 μm, the positive electrode active material 204 and the solid electrolyte 100 may be dispersed well in the positive electrode 201. This configuration improves the charge/discharge characteristics of the battery 1000. When the positive electrode active material 204 has a median diameter less than or equal to 100 μm, the lithium diffusion rate in the positive electrode active material 204 is high. The battery 1000 may thus operate with high output.

The positive electrode active material 204 may have a larger median diameter than the solid electrolyte 100. Thus, the positive electrode active material 204 and the solid electrolyte 100 may be dispersed well in the positive electrode 201.

To improve the energy density and output power of the battery 1000, the ratio of the volume of the positive electrode active material 204 to the total volume of the positive electrode active material 204 and the solid electrolyte 100 in the positive electrode 201 may be greater than or equal to 0.30 and less than or equal to 0.95.

The positive electrode active material 204 may have a coating layer on at least part of its surface. The coating layer may be formed on the surface of the positive electrode active material 204, for example, before the positive electrode active material 204 is mixed with a conductive assistant and a binder. Examples of the coating material contained in the coating layer include sulfide solid electrolytes, oxide solid electrolytes, and halide solid electrolytes. When the solid electrolyte 100 contains a sulfide solid electrolyte, the coating material may contain the solid electrolyte material according to the first embodiment to prevent or reduce the oxidative decomposition of the sulfide solid electrolyte. When the solid electrolyte 100 contains the solid electrolyte material according to the first embodiment, the coating material may contain an oxide solid electrolyte to prevent or reduce the oxidative decomposition of the solid electrolyte material. The oxide solid electrolyte may be lithium niobate having high stability at high potential. An increase in overpotential of the battery 1000 can be suppressed by preventing or reducing the oxidative decomposition.

To improve the energy density and output power of the battery 1000, the positive electrode 201 may have a thickness greater than or equal to 10 μm and less than or equal to 500 μm.

The electrolyte layer 202 contains an electrolyte material. The electrolyte material is, for example, a solid electrolyte material. The solid electrolyte material may contain the solid electrolyte material according to the first embodiment. The electrolyte layer 202 may be a solid electrolyte layer.

The electrolyte layer 202 may contain 50 mass % or more of the solid electrolyte material according to the first embodiment. The electrolyte layer 202 may contain 70 mass % or more of the solid electrolyte material according to the first embodiment. The electrolyte layer 202 may contain 90 mass % or more of the solid electrolyte material according to the first embodiment. The electrolyte layer 202 may consist of the solid electrolyte material according to the first embodiment.

Hereinafter, the solid electrolyte material according to the first embodiment is referred to as a first solid electrolyte material. A solid electrolyte material different from the first solid electrolyte material is referred to as a second solid electrolyte material.

The electrolyte layer 202 may further contain the second solid electrolyte material in addition to the first solid electrolyte material. In the electrolyte layer 202, the first solid electrolyte material and the second solid electrolyte material may be uniformly dispersed. A layer composed of the first solid electrolyte material and a layer composed of the second solid electrolyte material may be stacked in the stacking direction of the battery 1000.

The battery according to the second embodiment may include a positive electrode 201, a second electrolyte layer, a first electrolyte layer, and a negative electrode 203 in this order. The solid electrolyte material contained in the first electrolyte layer may have a lower reduction potential than the solid electrolyte material contained in the second electrolyte layer. The solid electrolyte material contained in the second electrolyte layer can thus be used while not being reduced. As a result, the battery 1000 may have improved charge/discharge efficiency. For example, when the second electrolyte layer contains the first solid electrolyte material, the first electrolyte layer may contain a sulfide solid electrolyte to prevent or reduce the reductive decomposition of the solid electrolyte material. As a result, the battery 1000 may have improved charge/discharge efficiency. The second electrolyte layer may contain the first solid electrolyte material. Having high oxidation resistance, the first solid electrolyte material can provide the battery with good charge/discharge characteristics.

The electrolyte layer 202 may consist of the second solid electrolyte material.

The electrolyte layer 202 may have a thickness greater than or equal to 1 μm and less than or equal to 1000 μm. When the electrolyte layer 202 has a thickness greater than or equal to 1 μm, short-circuiting is unlikely to occur between the positive electrode 201 and the negative electrode 203. When the electrolyte layer 202 has a thickness less than or equal to 1000 μm, the battery 1000 may operate with high output power.

Examples of the second solid electrolyte material include Li₂MgX₄, Li₂FeX₄, Li(Al,Ga,In)X₄, Li₃(Al,Ga,In)X₆, and LiI. In the formulas, X is at least one selected from the group consisting of F, Cl, Br, and I.

To improve the energy density and output power of the battery 1000, the electrolyte layer 202 may have a thickness greater than or equal to 1 μm and less than or equal to 1000 μm.

The negative electrode 203 contains a material capable of intercalating and deintercalating metal ions (e.g., lithium ions). The material is, for example, the negative electrode active material 205.

Examples of the negative electrode active material 205 include metal materials, carbon materials, oxides, nitrides, tin compounds, and silicon compounds. The metal materials may be single metals or alloys. Examples of the metal materials include lithium metal and lithium alloys. Examples of the carbon materials include natural graphite, coke, partially graphitized carbon, carbon fiber, spherical carbon, artificial graphite, and amorphous carbon. From the viewpoint of capacity density, suitable examples of the negative electrode active material include silicon (i.e., Si), tin (i.e., Sn), silicon compounds, and tin compounds.

The negative electrode active material 205 may be selected in consideration of the reduction resistance of the solid electrolyte material contained in the negative electrode 203. For example, when the negative electrode 203 contains the first solid electrolyte material, the negative electrode active material 205 may be a material capable of intercalating and deintercalating lithium ions at a voltage greater than or equal to 0.27 V with respect to lithium. Examples of the negative electrode active material include titanium oxides, indium metal, and lithium alloys. Examples of the titanium oxides include Li₄Ti₅O₁₂, LiTi₂O₄, and TiO₂. The use of the negative electrode active material can prevent or reduce the reductive decomposition of the first solid electrolyte material contained in the negative electrode 203. As a result, the battery 1000 may have improved charge/discharge efficiency.

The shape of the negative electrode active material 205 is not limited to a particular shape. The negative electrode active material 205 may be in the form of particles. The negative electrode active material 205 may have a median diameter greater than or equal to 0.1 μm and less than or equal to 100 μm. When the negative electrode active material 205 has a median diameter greater than or equal to 0.1 μm, the negative electrode active material 205 and the solid electrolyte 100 may be dispersed well in the negative electrode 203. This configuration improves the charge/discharge characteristics of the battery 1000. When the negative electrode active material 205 has a median diameter less than or equal to 100 μm, the lithium diffusion rate in the negative electrode active material 205 is high. The battery 1000 may thus operate with high output.

The negative electrode active material 205 may have a larger median diameter than the solid electrolyte 100. Thus, the negative electrode active material 205 and the solid electrolyte 100 may be dispersed well in the negative electrode 203.

To improve the energy density and output power of the battery 1000, the ratio of the volume of the negative electrode active material 205 to the total volume of the negative electrode active material 205 and the solid electrolyte 100 in the negative electrode 203 may be greater than or equal to 0.30 and less than or equal to 0.95.

To improve the energy density and output power of the battery 1000, the negative electrode 203 may have a thickness greater than or equal to 10 μm and less than or equal to 500 μm.

To increase the ion conductivity, chemical stability, and electrochemical stability, at least one selected from the group consisting of the positive electrode 201, the electrolyte layer 202, and the negative electrode 203 may contain the second solid electrolyte material.

The second solid electrolyte material may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

For example, when the electrolyte layer 202 contains the first solid electrolyte material, the negative electrode 203 may contain a sulfide solid electrolyte to prevent or reduce the reductive decomposition of the solid electrolyte material. The coating of the negative electrode active material with the sulfide solid electrolyte, which is electrochemically stable, can prevent or reduce contact between the first solid electrolyte material and the negative electrode active material. As a result, the battery 1000 may have reduced internal resistance.

The second solid electrolyte material may be an oxide solid electrolyte.

Examples of the oxide solid electrolyte include:
(i) NASICON solid electrolytes, such as LiTi₂(PO₄)₃ and its element-substituted products;
(ii) perovskite solid electrolytes, such as (LaLi)TiO₃;
(iii) LISICON solid electrolytes, such as Li₁₄ZnGe₄O₁₆, Li₄SiO₄, LiGeO₄, and their element-substituted products;
(iv) garnet solid electrolytes, such as Li₇La₃Zr₂O₁₂ and its element-substituted products; and
(v) Li₃PO₄ and its N-substituted products.

As described above, the second solid electrolyte material may be a halide solid electrolyte.

Examples of the halide solid electrolyte include Li₂MgX₄, Li₂FeX₄, Li(Al,Ga,In)X₄, Li₃(Al,Ga,In)X₆, and LiI. In the formulas, X is at least one selected from the group consisting of F, Cl, Br, and I.

Other examples of the halide solid electrolyte include compounds represented by LiₐMe_{b}Y_{c}Z₆. Here, a+mb+3c=6 and r>0 are satisfied. Me is at least one selected from the group consisting of metalloid elements and metal elements other than Li and Y. Z is at least one selected from the group consisting of F, Cl, Br, and I. m represents the valence of Me. The “metalloid elements” are B, Si, Ge, As, Sb, and Te. The “metal elements” are all elements (other than hydrogen) included in group 1 elements to group 12 elements in the periodic table and all elements (other than B, Si, Ge, As, Sb, Te, C, N, P, O, S, and Se) included in group 13 elements to group 16 elements in the periodic table.

To improve the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The halide solid electrolyte may be Li₃YCl₆ or Li₃YBr₆.

The second solid electrolyte material may be an organic polymer solid electrolyte.

Examples of the organic polymer solid electrolyte include a compound formed from a polymer compound and a lithium salt.

The polymer compound may have an ethylene oxide structure. Since the polymer compound having an ethylene oxide structure can contain a large amount of lithium salt, the polymer compound having an ethylene oxide structure can further improve the ion conductivity.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these lithium salts may be used alone. Alternatively, a mixture of two or more lithium salts selected from these lithium salts may be used.

To facilitate exchange of lithium ions and improve the output characteristics of the battery, at least one selected from the group consisting of the positive electrode 201, the electrolyte layer 202, and the negative electrode 203 may contain a non-aqueous electrolyte solution, a gel electrolyte, or an ionic liquid.

The non-aqueous electrolyte solution contains a non-aqueous solvent and a lithium salt dissolved in the non-aqueous solvent.

Examples of the non-aqueous solvent include cyclic carbonate solvents, chain carbonate solvents, cyclic ether solvents, chain ether solvents, cyclic ester solvents, chain ester solvents, and fluorinated solvents. Examples of the cyclic carbonate solvents include ethylene carbonate, propylene carbonate, and butylene carbonate. Examples of the chain carbonate solvents include dimethyl carbonate, ethyl methyl carbonate, and diethyl carbonate. Examples of the cyclic ether solvents include tetrahydrofuran, 1,4-dioxane, and 1,3-dioxolane. Examples of the chain ether solvents include 1,2-dimethoxyethane and 1,2-diethoxyethane. Examples of the cyclic ester solvents include y-butyrolactone. Examples of the chain ester solvents include methyl acetate. Examples of the fluorinated solvents include fluoroethylene carbonate, methyl fluoropropionate, fluorobenzene, fluoroethyl methyl carbonate, and fluorodimethylene carbonate. One non-aqueous solvent selected from these solvents may be used alone. Alternatively, two or more non-aqueous solvents selected from these solvents may be used in combination.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these lithium salts may be used alone. Alternatively, a mixture of two or more lithium salts selected from these lithium salts may be used. The concentration of the lithium salt is, for example, in the range greater than or equal to 0.5 mol/L and less than or equal to 2 mol/L.

The gel electrolyte may be a polymer material impregnated with a non-aqueous electrolyte solution. Examples of the polymer material include polyethylene oxide, polyacrylonitrile, polyvinylidene fluoride, polymethyl methacrylate, and a polymer having an ethylene oxide bond.

Examples of the cation contained in the ionic liquid include:
(i) aliphatic chain quaternary salts, such as tetraalkylammonium and tetraalkylphosphonium,
(ii) alicyclic ammoniums, such as pyrrolidinium, morpholinium, imidazolinium, tetrahydropyrimidinium, piperazinium, and piperidinium, and
(iii) nitrogen-containing heterocyclic aromatic cations, such as pyridinium and imidazolium.

Examples of the anion contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

To improve the close contact between particles, at least one selected from the group consisting of the positive electrode 201, the electrolyte layer 202, and the negative electrode 203 may contain a binder.

Examples of the binder include polyvinylidene fluoride, polytetrafluoroethylene, polyethylene, polypropylene, aramid resin, polyamide, polyimide, polyamideimide, polyacrylonitrile, poly(acrylic acid), poly(methyl acrylate), poly(ethyl acrylate), poly(hexyl acrylate), poly(methacrylic acid), poly(methyl methacrylate), poly(ethyl methacrylate), poly(hexyl methacrylate), poly(vinyl acetate), polyvinylpyrrolidone, polyether, polyethersulfone, hexafluoropolypropylene, styrene-butadiene rubber, and carboxymethylcellulose. Copolymers may also be used as a binder. Examples of such a binder include copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these materials may be used as a binder.

To improve the electron conductivity, at least one of the positive electrode 201 or the negative electrode 203 may contain a conductive assistant.

Examples of the conductive assistant include:
(i) graphites, such as natural graphite and artificial graphite;
(ii) carbon blacks, such as acetylene black and Ketjenblack;
(iii) conductive fibers, such as carbon fibers and metal fibers;
(iv) fluorinated carbon;
(v) metal powders, such as aluminum powder;
(vi) conductive whiskers, such as zinc oxide whisker and potassium titanate whisker;
(vii) conductive metal oxides, such as titanium oxide; and
(viii) conductive polymer compounds, such as polyaniline, polypyrrole, and polythiophene.
   For cost reduction, the conductive assistant (i) or (ii) may be used.

Examples of the shape of the battery according to the second embodiment include coin shape, cylindrical shape, prismatic shape, sheet shape, button shape, flat shape, and stack shape.

The battery according to the second embodiment may be manufactured by, for example, preparing materials for forming the positive electrode, materials for forming the electrolyte layer, and materials for forming the negative electrode, and producing, by a known method, a multilayer body including the positive electrode, the electrolyte layer, and the negative electrode in this order.

### EXAMPLES

The present disclosure will be described below in more detail with reference to Examples and Comparative Examples.

### Example 1

### Production of Solid Electrolyte Material

In an argon atmosphere having a dew point lower than or equal to −60° C. (hereinafter referred to as a “dry argon atmosphere”), LiF, ZrF₄, and AlF₃ were prepared as raw material powders at a molar ratio of LiF:ZrF₄:AlF₃=2.5:0.5:0.5. These raw material powders together with balls of Ø 1 mm (25 g) were placed in a 45-cc pod for planetary ball mills. To the pod, γ-butyrolactone (GBL) was added dropwise as an organic solvent such that the solid content was 30%. The solid content is calculated from {(mass of charged raw materials)/(mass of charged raw materials+mass of charged solvent)}×100. The mixture was milled in a planetary ball mill at 500 rpm for 12 hours. After the milling process, the balls were separated to obtain a slurry. The obtained slurry was dried at 200° C. for 1 hour under nitrogen flow by using a mantle heater. The obtained solid material was ground in a mortar to prepare a powder of a solid electrolyte material according to Example 1. The solid electrolyte material according to Example 1 had a composition represented by Li_{2.5}Zr_{0.5}Al_{0.5}F₆.

### Analysis of Crystal Structure

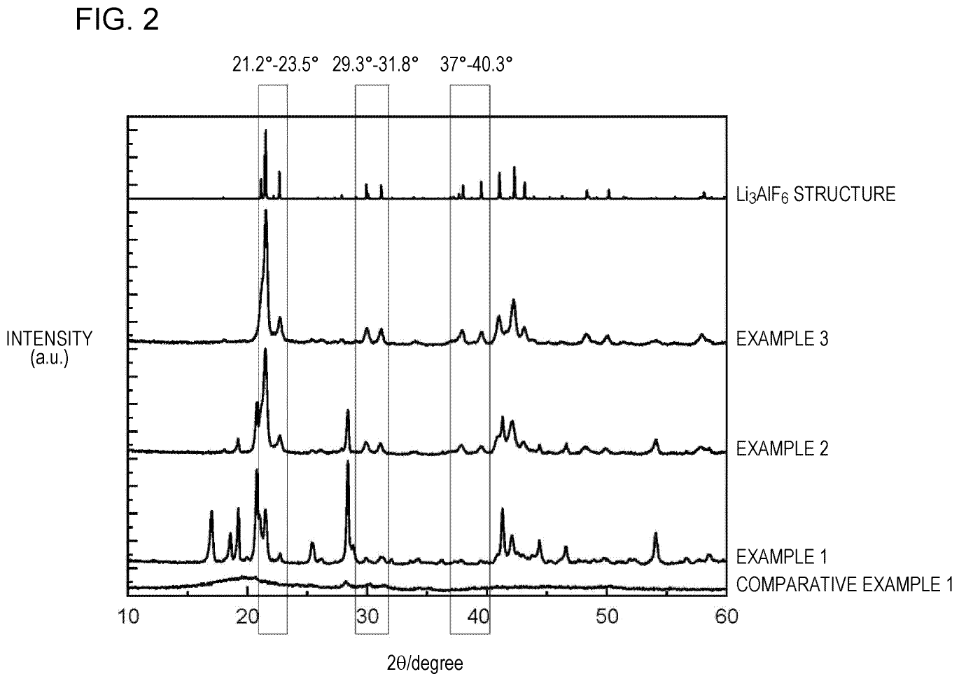

FIG. 2 is a graph showing the X-ray diffraction pattern of the solid electrolyte material according to Example 1. The results shown in FIG. 2 were obtained by the following method.

The X-ray diffraction pattern of the solid electrolyte material according to Example 1 was measured in a dry atmosphere having a dew point lower than or equal to −45° C. by using an X-ray diffractometer (MiniFlex600 available from Rigaku Corporation). As an X-ray source, Cu-Kα radiation (wavelength 1.5405 Å and 1.5444 Å) was used. The X-ray diffraction was measured by the θ-2θ method.

The X-ray diffraction pattern of the solid electrolyte material according to Example 1 had peaks with a relatively high intensity at 21.5°, 22.710, 29.84°, 31.1°, 37.86°, and 39.43°.

These peaks substantially coincided with some of peak positions of the X-ray diffraction profile observed from the LAF structure.

### Evaluation of Ion Conductivity

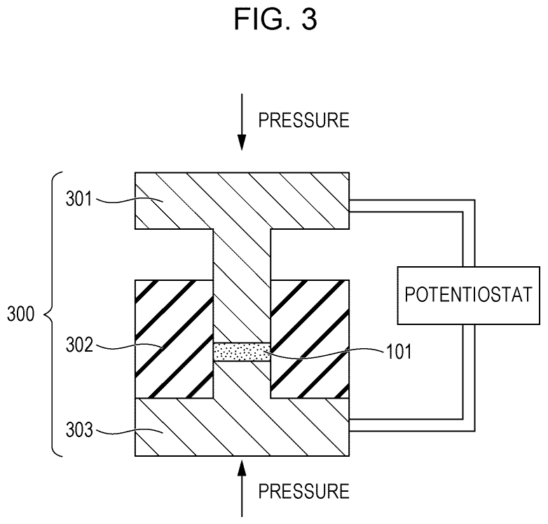

FIG. 3 is a schematic view of the compression molding die 300 used to evaluate the ion conductivity of the solid electrolyte material.

The compression molding die 300 included an upper punch 301, a die 302, and a lower punch 303. The die 302 was made of insulating polycarbonate. The upper punch 301 and the lower punch 303 were made of stainless steel having electron conductivity.

The ion conductivity of the solid electrolyte material according to Example 1 was evaluated by the following method using the compression molding die 300 shown in FIG. 3.

In a dry atmosphere having a dew point lower than or equal to −30° C., a powder of the solid electrolyte material according to Example 1 was charged into the compression molding die 300. In the compression molding die 300, a pressure of 400 MPa was applied to the solid electrolyte material according to Example 1 by using the upper punch 301 and the lower punch 303.

With the pressure applied, the upper punch 301 and the lower punch 303 were connected to a potentiostat (VSP-300 available from BioLogic) with a frequency response analyzer. The upper punch 301 was connected to a working electrode and a potential measuring terminal. The lower punch 303 was connected to a counter electrode and a reference electrode. The impedance of the solid electrolyte material was measured by the electrochemical impedance measuring method at room temperature.

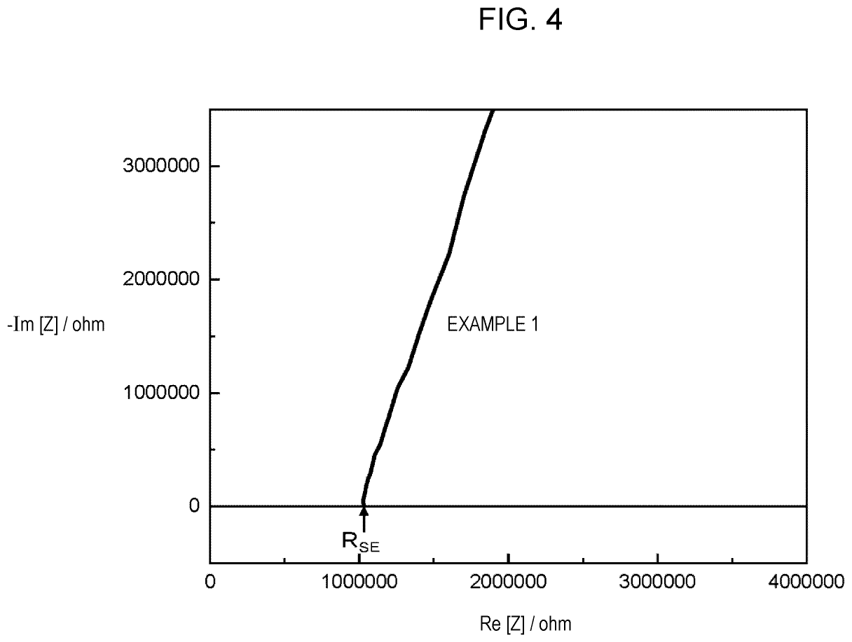

FIG. 4 is a graph showing the Cole-Cole plot obtained by impedance measurement of the solid electrolyte material according to Example 1.

In FIG. 4, the real value of impedance at the measurement point at which the absolute value of the phase of complex impedance was the smallest was regarded as the resistance of the solid electrolyte material to ion conduction. The real value is indicated by the arrow R_{SE} in FIG. 4. The ion conductivity was calculated on the basis of the following formula (2) using the resistance.

σ=(R_{SE}ΔS/t)⁻¹ (2)
where σ represents the ion conductivity. S represents an area of the solid electrolyte material that is in contact with the upper punch 301 (equivalent to the cross sectional area of the cavity in the die 302 in FIG. 3). R_{SE} represents the resistance of the solid electrolyte material in impedance measurement. t represents the thickness of the solid electrolyte material (i.e., the thickness of the layer composed of the powder 101 of the solid electrolyte material in FIG. 3).

The ion conductivity of the solid electrolyte material according to Example 1 measured at 25° C. was 7.88×10⁻⁸ S/cm.

### Evaluation of Heat Resistance

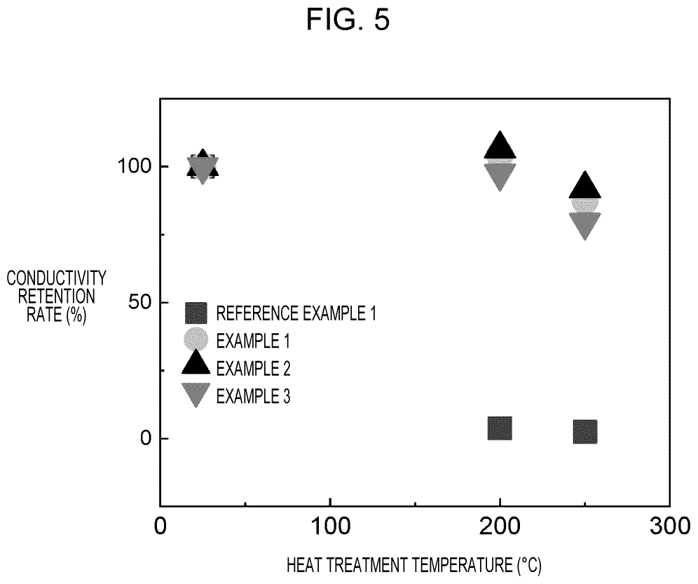

In a dry argon atmosphere, the solid electrolyte material according to Example 1 was placed in each of two alumina crucibles, and one alumina crucible was heat-treated at 200° C. for one hour, and the other alumina crucible was heat-treated at 250° C. for one hour. The solid materials obtained after the heat treatment were ground in a mortar as needed to produce heat-treated powder samples. The ion conductivity of the obtained powder samples was evaluated in the same manner as in the method described above in Evaluation of Ion Conductivity. Next, the ion conductivity retention rate after the heat treatment was calculated on the basis of the formula: (ion conductivity after heat treatment)/(ion conductivity before heat treatment)×100. FIG. 5 is a graph showing the conductivity retention rate of the solid electrolyte material according to Example 1 after the heat treatment.

As a result, the ion conductivity retention rates after the heat treatment of the solid electrolyte material according to Example 1 at 200° C. and 250° C. were 104.2% and 87.5%, respectively.

### Production of Battery

In a dry argon atmosphere, the solid electrolyte material according to Example 1 and LiCoO₂, which was an active material, were prepared at a volume ratio of 30:70. These materials were mixed in an agate mortar. A positive electrode mixture was produced accordingly.

In an insulating cylinder having an inner diameter of 9.5 mm, Li₃PS₄ (57.41 mg), the solid electrolyte material (26 mg) according to Example 1, and the positive electrode mixture (9.1 mg) were stacked in this order. A pressure of 300 MPa was applied to the obtained multilayer body to form the first electrolyte layer, the second electrolyte layer, and the positive electrode. In other words, the second electrolyte layer composed of the solid electrolyte material according to Example 1 was sandwiched between the first electrolyte layer and the positive electrode. The first electrolyte layer and the second electrolyte layer had a thickness of 450 μm and 150 μm, respectively.

Next, metal Li (thickness: 200 μm) was stacked on the first electrolyte layer. A pressure of 80 MPa was applied to the obtained multilayer body to form a negative electrode.

Next, a current collector made of stainless steel was attached to each of the positive electrode and the negative electrode, and a current collector lead was attached to each current collector.

Finally, the inside of the insulating cylinder was shut off from the outside atmosphere by using insulated ferrules, whereby the cylinder was sealed. A battery according to Example 1 was produced accordingly.

### Charge-Discharge Test

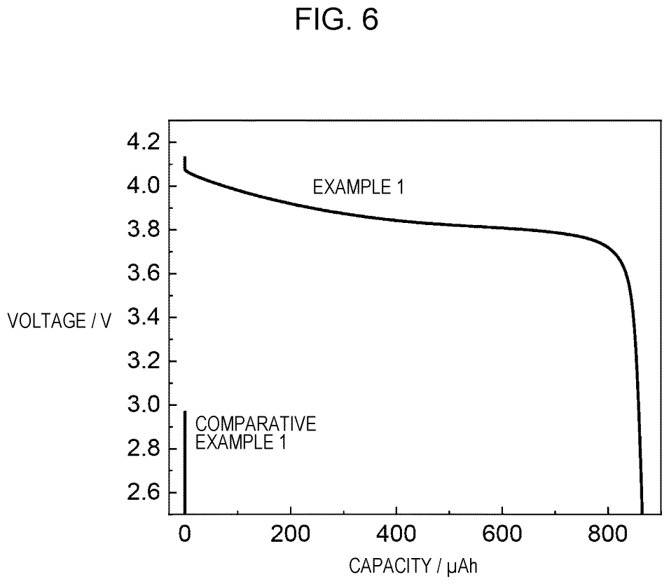

FIG. 6 is a graph showing the initial discharge characteristics of the battery according to Example 1. The initial charge/discharge characteristics were measured by the following method.

The battery according to Example 1 was placed in a thermostatic chamber at 85° C.

The battery according to Example 1 was charged to a voltage of 4.2 V at a current density of 13.5 μA/cm². This current density corresponds to 0.01 C rate.

Next, the battery according to Example 1 was discharged to a voltage of 2.5 V at a current density of 13.5 μA/cm².

As a result of the charge-discharge test, the battery according to Example 1 had an initial discharge capacity of 865 Ah.

### Examples 2 and 3

### Production of Solid Electrolyte Material

In Example 2, LiF, ZrF₄, and AlF₃ were prepared as raw material powders at a molar ratio of LiF:ZrF_{4:}AlF₃=2.8:0.2:0.8.

In Example 3, LiF, ZrF₄, and AlF₃ were prepared as raw material powders at a molar ratio of LiF:ZrF₄:AlF₃=2.9:0.1:0.9.

Otherwise, the solid electrolyte materials according to Examples 2 and 3 were produced in the same manner as in Example 1.

### Analysis of Crystal Structure

The X-ray diffraction patterns of the solid electrolyte materials according to Examples 2 and 3 were measured in the same manner as in Example 1. The results are shown in FIG. 2 and Table 2.

The X-ray diffraction patterns of the solid electrolyte materials according to Examples 2 and 3 had peaks that substantially coincided with the peaks from the LAF structure.

### Evaluation of Ion Conductivity

The ion conductivity of the solid electrolyte materials according to Examples 2 and 3 were measured in the same manner as in Example 1. The results are shown in Table 1.

### Evaluation of Heat Resistance

The heat resistance of the solid electrolyte materials according to Examples 2 and 3 was evaluated in the same manner as in Example 1. The ion conductivity retention rate of the solid electrolyte materials according to Examples 2 and 3 is shown in Table 1. FIG. 5 is a graph showing the conductivity retention rate of the solid electrolyte materials according to Examples 2 and 3 after the heat treatment.

### Charge-Discharge Test

Batteries according to Examples 2 and 3 were produced in the same manner as in Example 1 using the solid electrolyte materials according to Examples 2 and 3.

The charge-discharge test was carried out in the same manner as in Example 1 using the batteries according to Examples 2 and 3. As a result, the batteries according to Examples 2 and 3 were charged and discharged well.

### Reference Example 1

In a dry argon atmosphere, LiF, ZrF₄, and AlF₃ were prepared as raw material powders at a molar ratio of LiF:ZrF₄:AlF₃=2.5:0.5:0.5. These raw material powders were ground and mixed in a mortar. The produced mixed powder was milled in a planetary ball mill at 500 rpm for 12 hours. A solid electrolyte material according to Reference Example 1 was produced accordingly.

As described above, the solid electrolyte material according to Reference Example 1 was produced by dry ball milling without using an organic solvent.

The ion conductivity of the solid electrolyte material according to Reference Example 1 was measured in the same manner as in Example 1. As a result, the ion conductivity measured at 25° C. was 8.86×10⁻⁷ S/cm.

The analysis of the crystal structure and the evaluation of the heat resistance were carried out in the same manner as in Example 1 using the solid electrolyte material according to Reference Example 1.

The X-ray diffraction pattern of the solid electrolyte material according to Reference Example 1 showed that the solid electrolyte material according to Reference Example 1 mainly had an amorphous phase and had no peaks that coincided with the peaks from the LAF structure. In other words, the X-ray diffraction pattern of the solid electrolyte material according to Reference Example 1 is not characterized by “having at least two peaks in a first range of diffraction angle 2θ from 21.2° to 23.5°, at least two peaks in a second range of diffraction angle 2θ from 29.3° to 31.8°, and at least two peaks in a third range of diffraction angle 2θ from 370 to 40.3°.”

FIG. 5 is a graph showing the conductivity retention rate of the solid electrolyte material according to Reference Example 1 after the heat treatment. The ion conductivity retention rates after the heat treatment at 200° C. and 250° C. were 3.7% and 2.4%, respectively.

### Comparative Example 1

The ion conductivity was measured in the same manner as in Example 1 using LiBF₄ as a solid electrolyte material. As a result, the ion conductivity measured at 25° C. was 6.67×10⁻⁹ S/cm.

A battery according to Comparative Example 1 was produced in the same manner as in Example 1 except that the solid electrolyte material according to Comparative Example 1 was used as a solid electrolyte material used in the positive electrode mixture and the electrolyte layer.

The charge-discharge test was carried out in the same manner as in Example 1 using the battery according to Comparative Example 1. FIG. 6 is a graph showing the initial discharge characteristics of the battery according to Comparative Example 1. As a result, the initial discharge capacity of the battery according to Comparative Example 1 was less than or equal to 0.01 μAh. In other words, the battery according to Comparative Example 1 was not charged or discharged.

TABLE 1

| | | | | Ion | Ion |
|---|---|---|---|---|---|
| | | | | Conductivity | Conductivity |
| | | | Ion | Retention Rate | Retention Rate |
| | | Synthesis | Conductivity | (200° C.) | (250° C.) |
| | Composition | Method | [S/cm] | [%] | [%] |
| Example 1 | Li_{2.5}Zr_{0.5}Al_{0.5}F₆ | wet BM | 7.88 × 10⁻⁸ | 104.2 | 87.5 |
| Example 2 | Li_{2.8}Zr_{0.2}Al_{0.8}F₆ | wet BM | 1.15 × 10⁻⁷ | 106.5 | 91.9 |
| Example 3 | Li_{2.9}Zr_{0.1}Al_{0.9}F₆ | wet BM | 7.71 × 10⁻⁸ | 97.5 | 79.5 |
| Reference | Li_{2.5}Zr_{0.5}Al_{0.5}F₆ | dry BM | 8.86 × 10⁻⁷ | 3.7 | 2.4 |
| Example 1 | | | | | |
| Comparative | LiBF₄ | — | 6.67 × 10⁻⁹ | — | — |
| Example 1 | | | | | |

TABLE 2

| | | Synthesis | | | | | | |
|---|---|---|---|---|---|---|---|---|
| | Composition | Method | XRD Peak Position [°] | | | | | |
| Example 1 | Li_{2.5}Zr_{0.5}Al_{0.5}F₆ | wet BM | 21.5 | 22.71 | 29.84 | 31.1 | 37.86 | 39.43 |
| Example 2 | Li_{2.8}Zr_{0.2}Al_{0.8}F₆ | wet BM | 21.5 | 22.7 | 29.87 | 31.09 | 37.87 | 39.55 |
| Example 3 | Li_{2.9}Zr_{0.1}Al_{0.9}F₆ | wet BM | 21.54 | 22.71 | 29.95 | 31.17 | 37.93 | 39.54 |

### DISCUSSION

The solid electrolyte materials according to Examples 1 to 3 had an ion conductivity greater than or equal to 7×10⁻⁹ S/cm at room temperature.

The solid electrolyte materials according to Examples 1 to 3 had a higher ion conductivity retention rate than that of Reference Example 1 having an amorphous phase. In other words, the solid electrolyte materials according to Examples 1 to 3 had high heat resistance.

The solid electrolyte materials according to Examples 1 and 2, which have at least two peaks in a range of diffraction angle 2θ from 15° to 20° in the X-ray diffraction pattern, have higher heat resistance than the solid electrolyte material according to Example 3, which does not have two peaks in this range.

The batteries according to Examples 1 to 3 were all charged and discharged at 85° C. In contrast, the battery according to Comparative Example 1 was not charged or discharged.

Being free of sulfur, the solid electrolyte materials according to Examples 1 to 3 produce no hydrogen sulfide.

As described above, the solid electrolyte material according to the present disclosure is suitable for providing a battery that can be charged and discharged well since the solid electrolyte material according to the present disclosure has high lithium-ion conductivity and has heat resistance that is expected to be stable against the heat generated during the battery production process.

The solid electrolyte material according to the present disclosure is used in, for example, all-solid-state lithium-ion secondary batteries.

What is claimed is:

1. A solid electrolyte material comprising a crystal phase containing Li, Zr, Al, and F,
wherein an X-ray diffraction pattern of the solid electrolyte material obtained by X-ray structure analysis using Cu-Kα radiation has
at least two peaks in a first range of diffraction angle 2θ from 21.2° to 23.5°,
at least two peaks in a second range of diffraction angle 2θ from 29.3° to 31.8°, and
at least two peaks in a third range of diffraction angle 2θ from 370 to 40.3°.

2. The solid electrolyte material according to claim 1,
wherein a half or more of cations other than Li constituting the solid electrolyte material have an anion coordination number of 6 in a crystal structure.

3. The solid electrolyte material according to claim 1,
wherein the crystal phase has a Li₃AlF₆ structure or a distorted Li₃AlF₆ structure.

4. The solid electrolyte material according to claim 1,
wherein the crystal phase is represented by formula (1) below:
Li_{6-(4-x)b}(Zr₁₋ₓAlₓ)_{b}F₆ (1)
where 0<x<1 and 0<b≤1.5 are satisfied.

5. The solid electrolyte material according to claim 4,
wherein 0.5≤x≤0.9 is satisfied in the formula (1).

6. The solid electrolyte material according to claim 1,
wherein the X-ray diffraction pattern has
at least two peaks in a fourth range of diffraction angle 2θ from 150 to 20°.

7. A battery comprising:
a positive electrode;
a negative electrode; and
an electrolyte layer disposed between the positive electrode and the negative electrode,
wherein at least one selected from the group consisting of the positive electrode, the negative electrode, and the electrolyte layer contains the solid electrolyte material according to claim 1.
